(19) United States
(12) Patent Application Publication
(10) Pub. No.: US 2013/0018700 A1
(43) Pub. Date: Jan. 17, 2013

(54) OPTIMIZING PRODUCT PORTFOLIOS UNDER CUSTOMER CHOICE

(71) Applicants: Thomas R. Ervolina, Poughquag, NY (US); Markus R. Ettl, Ossining, NY (US); Soumyadip Ghosh, PeekSkill, NY (US); Donna Leigh Gresh, Cortlandt Manor, NY (US); Sechan Oh, Stanford, CT (US)

(72) Inventors: Thomas R. Ervolina, Poughquag, NY (US); Markus R. Ettl, Ossining, NY (US); Soumyadip Ghosh, PeekSkill, NY (US); Donna Leigh Gresh, Cortlandt Manor, NY (US); Sechan Oh, Stanford, CT (US)

(73) Assignee: INTERNATIONAL BUSINESS MACHINES CORPORATION, Armonk, NY (US)

(21) Appl. No.: 13/183,058

(22) Filed: Jul. 14, 2011

(51) Int. Cl. G06Q 10/00; G06F 17/11

(52) U.S. Cl. 705/7.31

(57) ABSTRACT

A method and system are disclosed for managing configurable products via solving an optimization problem. In one embodiment, the method comprises collecting data from a software application and a user; formulating a set of constraints based on the collected data; defining the optimization problem by the set of constraints and an optimization objective; solving the optimization problem using the collected data, the set of constraints, the optimization objective and the objective function via mixed integer programming; and outputting a solution of the optimization problem.

### TECHNICAL FIELD

The present disclosure generally relates to product supply chain management. In particular, the present disclosure relates to a technology for optimizing management of configurable product portfolios.

### BACKGROUND

Offering a variety of products is critical for manufacturing and retail firms to maintain a competitive edge. By providing a wide product portfolio, firms try to capture demand from a diverse group of customers who have heterogeneous product valuations and budget constraints. For example, computer manufacturers provide multiple lines of computer servers, where each product line consists of tens of different product families. For each product family, consumers also have the option of customizing components such as the system processor and hard drive.

The increase in product variety, however, results in an increase in operating costs. Planning a larger number of products makes the management of a supply chain more challenging. A wide product portfolio also drives a drastic increase of inventory costs. Some technologies have generally focused on determining the optimal product portfolio that balances the trade-off between product coverage and production complexity cost. Evidence of such complexity costs enables an identification of an optimal set of core products that drive customer demand (by maximizing demand coverage). While reducing the product portfolio has limited consequences for large retailers, smaller operators are reluctant to reduce perceived product variety in today's competitive environment since consumers now have a more transparent view of available products across different firms through online retail channels. Further, eliminating a product from the portfolio is especially risky in the presence of basket shopping consumers who purchase products from multiple categories at the same time.

Accordingly, it would be desirable to provide a technology to reduce the complexity cost without impacting the portfolio variety or total demand coverage.

### BRIEF SUMMARY

Accordingly, the disclosed technology generally reduces the complexity cost without impacting the portfolio variety or total demand coverage.

An exemplary embodiment of the disclosed technology is a computer-implemented method for managing configurable products via solving an optimization problem having an objective function and a set of constraints, the method comprising: collecting data from a software application and a user, said data including a product configuration and a component provision in a pre-determined time period and potential substitutes that can be used in which configurations; formulating the set of constraints based on the collected data, the set of constraints having a configuration provision constraint setting forth a base component of a product or valid substitutes thereof and a substitution rule constraint defining a priority order in which components of a product configuration may be substuituted over other components; defining the optimization problem by the set of constraints and an optimization objective, wherein the optimization objective is profit-based, said optimization problem including a function representing a profit from sales of said provided configurations using said base component, and a correction factor, adjusting for a difference in profit by using a substituted component; solving the optimization problem using the collected data, the set of constraints, the optimization objective and the objective function via mixed integer programming to determine a subset of components to be provided in a pre-determined time period and whether a product configuration should use one or more substitute components outputting a solution of the optimization problem, wherein the solution output comprises in each time period, which component parts should be added or dropped from a product portfolio to maximize profit from sales of the configured products.

An exemplary embodiment of the disclosed technology is a computer program product for managing configurable products via solving an optimization problem having an objective function and a set of constraints, the computer program product comprising: a storage medium readable by a processing circuit and storing instructions for execution by the processing circuit for performing a method comprising: collecting data from a software application and a user, said data including a product configuration and a component provision in a pre-determined time period and potential substitutes that can be used in which configurations; formulating the set of constraints based on the collected data, the set of constraints having a configuration provision constraint setting forth a base component of a product or valid substitutes thereof and a substitution rule constraint defining a priority order in which components of a product configuration may be substuituted over other components; defining the optimization problem by the set of constraints and an optimization objective, wherein the optimization objective is profit-based, said optimization problem including a function representing a profit from sales of said provided configurations using said base component, and a correction factor, adjusting for a difference in profit by using a substituted component; solving the optimization problem using the collected data, the set of constraints, the optimization objective and the objective function via mixed integer programming to determine a subset of components to be provided in a pre-determined time period and whether a product configuration should use one or more substitute components outputting a solution of the optimization problem, wherein the solution output comprises in each time period, which component parts should be added or dropped from a product portfolio to maximize profit from sales of the configured products.

An exemplary embodiment of the disclosed technology is a computer system for managing configurable products via solving an optimization problem having an objective function and a set of constraints, the system comprising: a memory; a processor in communications with the computer memory, wherein the computer system is capable of performing a method comprising: collecting data from a software application and a user, said data including a product configuration and a component provision in a pre-determined time period and potential substitutes that can be used in which configurations; formulating the set of constraints based on the collected data, the set of constraints having a configuration provision constraint setting forth a base component of a product or valid substitutes thereof and a substitution rule constraint defining a priority order in which components of a product configuration may be substuituted over other components; defining the optimization problem by the set of constraints and an optimization objective, wherein the optimization objective is profit-based, said optimization problem including a function representing a profit from sales of said provided configurations using said base component, and a correction factor, adjusting for a difference in profit by using a substituted component; solving the optimization problem using the collected data, the set of constraints, the optimization objective and the objective function via mixed integer programming to determine a subset of components to be provided in a pre-determined time period and whether a product configuration should use one or more substitute components outputting a solution of the optimization problem, wherein the solution output comprises in each time period, which component parts should be added or dropped from a product portfolio to maximize profit from sales of the configured products.

### BRIEF DESCRIPTION OF THE DRAWINGS

The objects, features and advantages of the disclosed technology will become apparent to one skilled in the art in view of the following detailed description taken in combination with the attached drawings, in which:

FIG. 1 symbolically shows a block diagram illustrating an exemplary embodiment of a system architecture overview, according to the disclosed technology;

FIG. 2 symbolically shows a flowchart illustrating an exemplary embodiment of a computer-implemented process configured to solve an optimization problem;

FIG. 3 symbolically shows an exemplary embodiment of a hardware configuration performing product portfolio optimization under customer choice.

### DETAILED DESCRIPTION OF THE PREFERRED EMBODIMENTS

In an exemplary embodiment, the disclosed technology is generally directed toward a firm-driven demand substitution model that enables a retailer to make strategic decisions to fulfill demand for certain products with alternative products. The retailer realizes savings in overall operational costs by eliminating these products from inventory planning operations, which is further aided by beneficial effects, such as increased risk-pooling. Meanwhile, the portfolio perceived by customers remains the same as they are still allowed to place orders for these products. The retailer may provide additional incentives to appease customers who do not get their most preferred product. This approach is in contrast to the customer-choice model where, for example, retailers may eliminate products from the customer-exposed portfolio when constrained by other factors, such as limited retail-space.

In an exemplary embodiment, the disclosed technology is generally directed toward a procure-to-sell model where the retailer initially eliminates some products from centralized planning, such as inventory planning. When customers place orders for these products, the retailer procures them either directly from a supplier or from a third party through a special procurement process. Special procurements incur extra costs, but this model removes inventory costs involved with the corresponding products.

In an exemplary embodiment, the disclosed technology enables development of a system of management of configurable products. The configurable products may be assembled from components, portfolio of components as well as products actively managed. The system enables capture of dynamic relationships between elements of product portfolio.

In an exemplary embodiment, the disclosed technology further enables capture of customer choice behavior. Customers may be offered incentives to choose alternates if the desired product is not supported and priority may be established for component substitution that reflects customer requirements.

In an exemplary embodiment, the disclosed technology additionally enables incorporation of stochastic demand and supply for predictive analysis. Instead of being viewed as deterministic, demand and supply forecasts are modeled as random variables allowing for a richer understanding of possible outcomes and a more robust data analysis.

In an exemplary embodiment, the disclosed technology also enables minimization, due to simpler portfolio, of feature-inclusion costs by accurately capturing trade-off between portfolio complexity and opportunity cost of lost sales.

While, for simplicity and clarity, the following description of the figures is provided in reference to a computer manufacturer/retailer business model, the disclosed technology is not limited to this business model. Rather, the disclosed technology may be implemented and used with any business model that requires management of a configurable product supply chain.

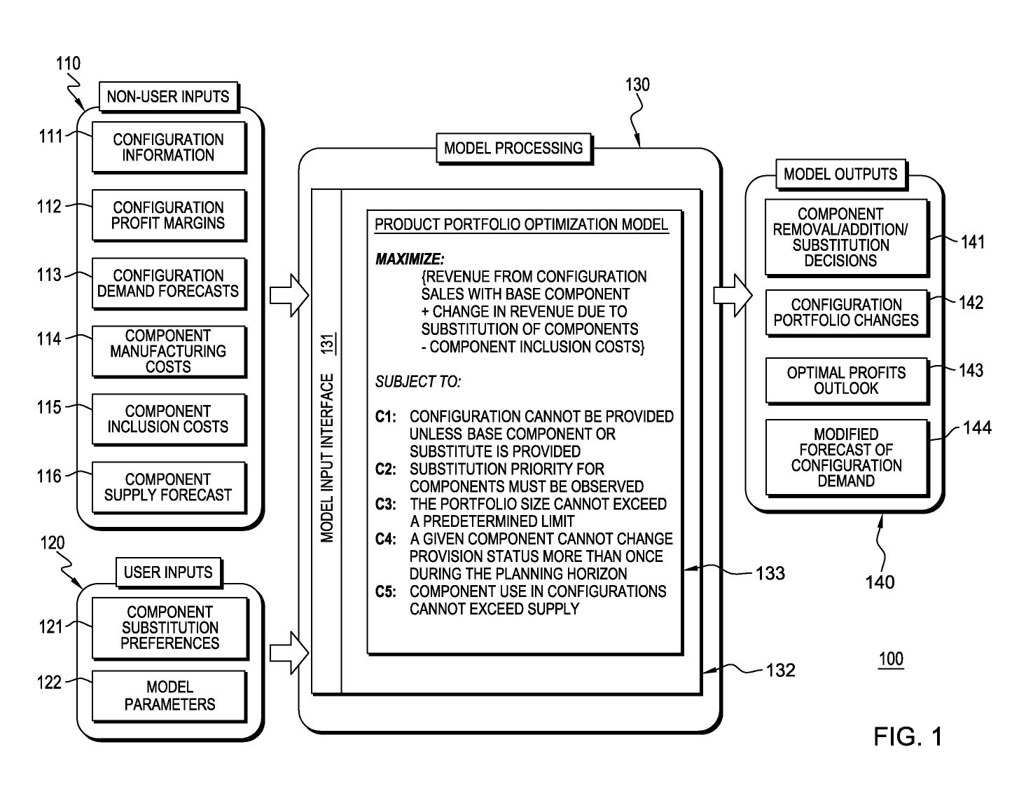

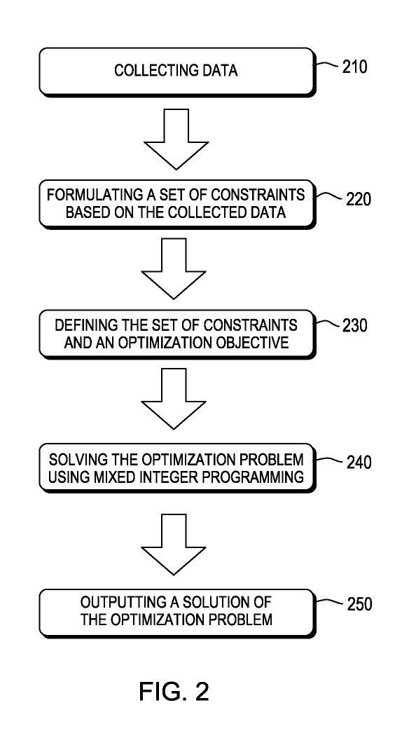

FIG. 1 symbolically shows a block diagram illustrating an exemplary embodiment of a system architecture overview, according to the disclosed technology. FIG. 2 symbolically shows a flowchart illustrating an exemplary embodiment of a computer-implemented process configured to solve an optimization problem. System 100 includes model inputs (step 210 in FIG. 2), which includes a non-user input 110 and a user input 120, model processing 130 and model output 140.

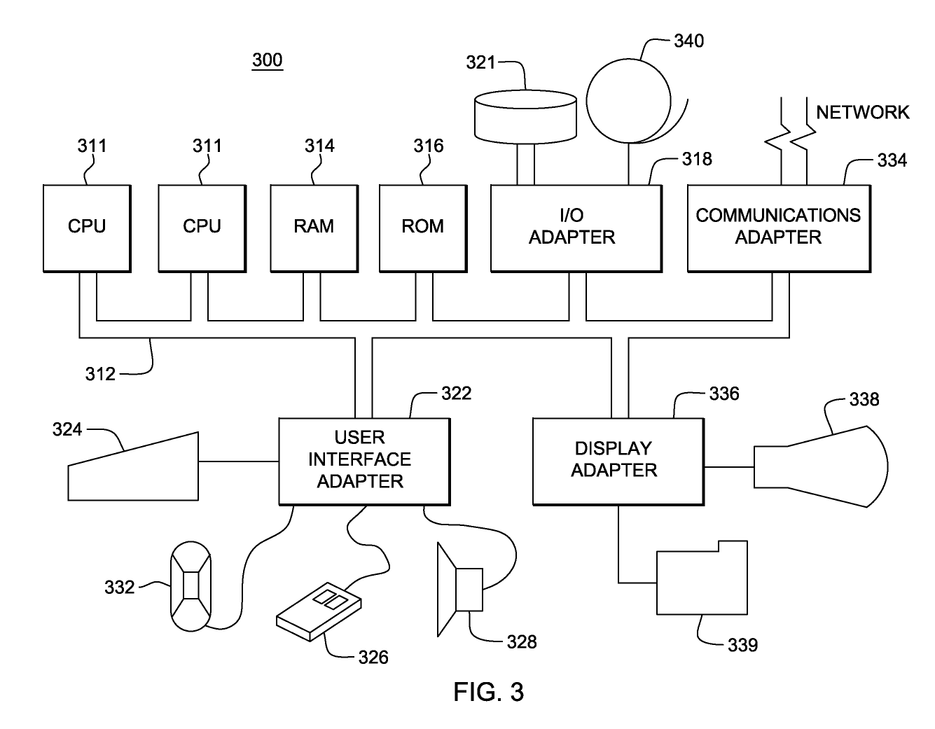

Non-user input 110 comprises configuration data 111, configuration profit margins data 112, configuration demand forecast data 113, component manufacturing costs data 114, component inclusion costs data 115 and component supply forecast data 116. Non-user input 110 may be statically stored within one database or multiple databases in any combination on any number of computing devices such as shown in a computer system as described herein with respect to FIG. 3. Non-user input 110 may also be calculated on-the-fly and consequently be retrieved from a single or multiple data sources. In an exemplary embodiment, non-user input 110 may be retrieved via a query language, such as SQL.

Generally, configuration data 111 and configuration profit margins data 112 provide for management of configured products. Configuration demand data 113 and component supply forecast data 116 provide for incorporation into the model of stochastic demand and supply for predictive analysis. Component manufacturing costs data 114 and component inclusion costs data 115 provide for management of feature-inclusion costs.

Configuration data 111 provides information describing various configurations of configurable goods within a managed inventory. In an exemplary embodiment, in reference to the previously described computer manufacturer/retailer business model, configuration data 111 describes computer inventory configurations, such as a computer model with a hard drive, a processor chip and a memory chip as individual components. Each configuration is associated with a base component configuration. In reference to a mathematical formulation subsequently described, configuration a has a base component oⁱ(a) and uses bⁱ(a) in component family I in sample formulation.

Configuration profit margins data 112 provides information describing profit margins obtained from selling a single configurable product. Configuration profit margins data 112 can vary if substitute components are chosen over a base component. In an exemplary embodiment, in reference to the previously described computer manufacturer/retailer business model, if a retailer with a certain profit margin is unable to sell a certain outdated component and instead, to retain a potential customer, attempts to sell a more expensive substitute component and the potential customer may walk away due to a higher price, then, in order to make the sale, the retailer may reduce its profit margin to what the profit margin would be had the sale with the outdated component took place. In reference to the mathematical formulation subsequently described, configuration profit margins data 112 corresponds to parameters fₐ and fⁱₐⱼₖ.

Configuration demand forecast data 113 provides information describing configuration demand forecasts over a defined planning horizon. Configuration demand forecast data is obtained at a configuration level. In an exemplary embodiment, in reference to the previously described computer manufacturer/retailer business model, a configuration demand forecast may describe the planning horizon in reference to the expected configuration forecast over a fixed time period, which may be broken down into one or more smaller time period segments, e.g., weeks, months, quarters. In reference to the mathematical formulation subsequently described, configuration a has demand forecast V_{a,t}.

Component manufacturing costs data 114 provides information describing retailer costs incurred in purchasing base components in configuration and their potential substitutes. In an exemplary embodiment, in reference to the previously described computer manufacturer/retailer business model, component manufacturing costs may be retailer costs incurred with purchasing various types of processor chips at a volume from a chip vendor. In reference to the mathematical formulation subsequently described, component manufacturing costs data 114 correspond to cₐ for configuration a and cⁱⱼ for component j in family i.

Component inclusion costs data 115 provides information describing retailer costs incurred in managing and maintaining its inventory. Component inclusion costs can vary by component type and include costs, such as inventory holding costs and compatibility maintenance costs.

Component supply forecast data 116 provides information describing component supply forecasts over a defined planning horizon. Component supply data is obtained at a component level. In an exemplary embodiment, in reference to the previously described computer manufacturer/retailer business model, a component supply forecast may describe expected upper limit of supply that is available over a fixed time period. In reference to the mathematical formulation subsequently described, component supply forecast corresponds to Uⁱ_{j,t}.

User input 120 comprises component substitution preferences data 121 and model parameters data 122. Generally, user input 120 includes information that affects decisions that will have to be made in the future and is received from a user by a processing engine 132. The user may be a human user or a software module invoking performance of processing engine 132. Generally, component substitution preferences data 121 and model parameters data 122 provide data to enable capture of customer choice behavior.

Component substitution preferences data 121 provides information as to what is a viable substitute for a component that is being dropped from inventory. A user may input data, for example, in the form of a matrix of substitution logic for all components in a product portfolio. In an exemplary embodiment, component substitution preferences data 121 may state that for a certain component most preferable substitute is one certain component, the second most preferable substitute component is a second certain component and the third most preferable substitute component is a third certain component. In reference to the mathematical formulation subsequently described, component substitution preferences data 121 corresponds to parameters sⁱ(j,k) and nⁱⱼ.

Model parameters data 122 provides information as to the discount rate and maximum number of components allowed in a product portfolio. In an exemplary embodiment, in reference to the previously described computer manufacturer/retailer business model, if a retailer with a certain profit margin is unable to sell a certain outdated component and instead, to retain a potential customer, attempts to sell a more expensive substitute component and the potential customer may walk away due to a higher price, then, in order to make the sale, the retailer may reduce its profit margin, in accordance with a pre-specified discount, to what the profit margin would be had the sale with the outdated component took place. In an exemplary embodiment, model parameters data 122 is input via a text field or via a form on an internet webpage. In reference to the mathematical formulation subsequently described, model parameters data 122 corresponds to parameters beta and alpha^{u}ₜ, respectively.

Model processing 130 comprises a model input interface 131, processing engine 132 and a model 133.

Model input interface 131 is used to filter and format non-user input 110 and user input 120 in preparation for use in processing engine 132. In an exemplary embodiment, model input interface 131 performs at least one of the three subsequently described tasks.

In an exemplary embodiment, one task performed by model input interface 131 is a formulation task, which combines inputs 110 and 120 and formulates them into mathematical inputs directly required by processing engine 132. As per mathematical formulation subsequently described, model input interface 131 receives the user data and non-user data inputs and converts the inputs into the specific mathematical formats required to specify a set of constraints, e.g., constraints C1, C2, C3, C4, C5, in the embodiment described, and an objective function.

In an exemplary embodiment, another task performed by model input interface 131 is a filtering task, which assesses the input data received and filters out any data that is not complete. In an exemplary embodiment, if a particular input, such as configuration profit margin data 112, is provided for a configuration that has no corresponding configuration information data 111, then the filtering task ensures that none of the data for this configuration is presented to processing engine 132 (otherwise, engine 132 may not properly perform). In an exemplary embodiment, if a set of offered products has multiple different product families, then a user of processing engine 132 might want to focus the analysis on a single product brand and thus the filtering task ensures that only the input data associated with the desired brand is presented to processing engine 132. Hence, for example, if an automaker manufactures automobiles and lawn equipment, then the filtering task ensures that only data for the automobile brands is presented to processing engine 132.

In an exemplary embodiment, yet another task performed by model input interface 131 is a copying task, which electronically copies and formats the relevant data from an original source, such as a database or a user of processing engine 132, to the electronic format compatible with processing engine 132. In an exemplary embodiment, processing engine 132 may be compatible with data in an Extensible Markup Language (XML) file format.

Model 133 runs on processing engine 132. In an exemplary embodiment, processing engine 132 is mathematical solver software specifically designed for solving mathematical problems of the form as described in this disclosure. This form of mathematical problem is called a Mixed Integer Program (MIP) and therefore the processing engine is specifically built using a MIP solver. One example of a MIP solver software is IBM ILOG CPlex® software. In an exemplary embodiment, following input 110 and 120, model 133 outputs output 140 that enables management of configurable components in a product portfolio. In an exemplary embodiment, model 133 generally maximizes revenue from configuration sales with base components and changes in revenue due to substitution of components taking into account component inclusion costs.

Model 133 runs (step 240 in FIG. 2) subject to constraints C1, C2, C3, C4 and C5 (steps 220 and 230 in FIG. 2). Configuration provision constraint C1 provides that a given configuration cannot be provided unless its base component or a valid substitute component is provided. Substitution rules constraint C2 provides that a substitution priority for components must be observed i.e. a component cannot be used as a substitute in a configuration if a more preferred component is provided in a given period. Portfolio complexity constraint C3 provides that the product portfolio size (total number of components provided in each period) cannot exceed a predetermined limit. Status changes constraint C4 provides that a given component cannot change provision status more than once during the planning horizon. Supply constraint C5 provides that component use in configurations cannot exceed supply. Model 133 is subsequently described in even more detail.

In an exemplary embodiment, model output 140 represents extracted outputs of processing engine 132 into information that directs a user on how to manage a configuration of products. Model output 140 represents the final analysis taking into account all model inputs that were run though processing engine 132. Model output 140 (step 250 in FIG. 2) comprises component removal/addition/substitution decisions data 141, configuration portfolio changes data 142, optimal profits outlook data 143 and modified forecast of configuration demand data 144.

Generally, component removal/addition/substitution decisions data 141 provides for feature-inclusion costs, capture of customer choice behavior and incorporation of stochastic demand and supply for predictive analysis. Configuration portfolio changes data 142 provides for management of configured products and incorporation of stochastic demand and supply for predictive analysis. Optimal profits outlook data 143 provides for incorporation of stochastic demand and supply for predictive analysis. Modified forecast of configuration demand data 144 provides for predictive analysis.

Component removal/addition/substitution decisions data 141 provides information describing which components to add/drop/substitute from a product portfolio in a time period. In reference to the mathematical formulation subsequently described, component removal/addition/substitution decisions data 141 corresponds to model output variables xⁱⱼₜ and yⁱⱼₖₜ. In an exemplary embodiment, component removal/addition/substitution decisions data 141 may state that component A be dropped, component B be dropped and substituted with component C and component D be added.

Configuration portfolio changes data 142 provides information describing which product configurations to add/drop in a time period based on the components chosen for use in the model. In reference to the mathematical formulation subsequently described, configuration portfolio changes data 142 corresponds to output variable zₐ. In an exemplary embodiment, configuration portfolio changes data 142 may state that configuration 25 be dropped if configuration 25 includes component 114 (see immediately above) and configuration 10 be added if configuration 10 includes component 110 (see immediately above) for a certain time period.

Optimal profits outlook data 143 provides information describing optimal profit for a time period given the optimal decisions about components and configurations provided in the product portfolio. In an exemplary embodiment, optimal profits outlook data 143 may state that for one time period profit may be $10 k and for another time period the profit may be $20 k.

Modified forecast of configuration demand data 144 provides information describing modified input forecast of configuration and component demand given optimal decisions on component and configuration availability. In an exemplary embodiment, modified forecast of configuration demand data 144 provides information to a user on how the forecast of configuration demand will be modified based on the recommended solution provided by running of model 133 on processing engine 132. For example, modified forecast of configuration demand data 144 may suggest to a user what changes to make to their product portfolio and what the user can expect his demand forecast to be, if he makes those changes.

Referring back to model 133, in an exemplary embodiment, model 133 is described in reference to a retailer who sells a portfolio of multiple products. Model 133 describes a sales season of the retailer that consists of a horizon of one or more time periods (each period being a fixed time length, such as a month or three months). At the beginning of the sales season, the manufacturer has to determine the transition dynamics of their product portfolio. Specifically, the model focuses on situations where firms sell aggregate units, such as cars or computers, that are comprised of various individual parts that have some level of interchangeability. Model 133 determines, in each time period, which parts should be added and dropped from the portfolio to maximize profit from sales of the configured products, subject to a limit on the size of the portfolio in each period.

More formally, let aεA represent a specific offering of the aggregate unit, or configuration. For each configuration a, given are fₐ, the profit margin, cₐ, the total costs of a when it uses a default, or “base” component set, and V_{a,t} the demand for a in period t.

Let iεI represent a specific category of component which goes into completed configurations. In the case of an example computer product, an example component would include hard drives. Within each family i of components, let (i,j)εJᵢ be a specific type of component within that family, such as 1 terabyte SATA drive, and cⁱⱼ be the cost of component (i,j). gⁱⱼ represents the initial component provision status since an interest is in solutions where components can change provision status from their initial status at most once during the planning horizon.

The retailer may eliminate a subset of products from planning, and fulfill demands for these products with alternatives from the core set of planned products. In the computer retailing industry, retailers are often forced to retain older technology products in their portfolio if they are still offered by their competitors. When demand for these products is very low, retailers can choose to fulfill them using newer technology products instead of truly keeping them on hand. An assumption is that knowledge about which components can act as substitutes for others in given configurations, and a preference priority on how they are substituted, can be determined in advance. Several considerations go into creating this information, such as technical feasiblity of substitution, stability of the configuration with the substitute part, cost change reduction. For example, in the car example, a specific model of car comes with a default wheel, but there are several other wheels that also fit the car and can serve as substitutes. However, the manufacturer has a preferred first alternative they wish to use if the base is not available and a second alternative to use if the first alternative is not available. In an exemplary embodiment of the substitution logic, the complete product set is sorted by increasing procurement costs and the retailer can meet the demand of a product that is eliminated with the product that has the next higher procurement cost. This is allowed only if the substitute product itself is a planned product, otherwise demand for the eliminated product is unmet.

Let the base component in family i of configuration a be oⁱ(a) and let the k th substitute for a given component (i,j) be indexed as sⁱ(j,k), with nⁱⱼ total alternatives of (i,j). The configuration uses bⁱₜ(a) components from family i in period t, and fⁱ_{j,k} is the adjusted profit margin when component j is substituted by its k th alternative.

Customers pay a discounted price for the substitute product, which is between the price of the original product and the substitute. Customers are not provided any prior information about the manufacturer's planning/fulfillment decision and thus are assumed not to act strategically by ordering products in anticipation of obtaining a higher-valued product at a discount. The strategic substitution decision made by the retailer affect planning decisions for products in the core portfolio if they serve as substitutes for eliminated products. The demand consolidation over a substitute product changes the mean and variance parameters of its demand, while discounts modify the average unit revenue. Under this scenario, products in the substituted set result in zero total profit.

Finally, there exist various implicit and explicit costs to having a larger portfolio in any period. However, by their nature these costs may be difficult to accurately measure. Thus, instead of incorporating those costs directly, introduced is αⁱₜ as an upper limit on the size of the portfolio (total number of components provided) in each period t. By varying αⁱₜ the optimum profit at each constraint level can be examined. Inspection of this profit curve as a function of αⁱₜ gives insight into the marginal benefit of having a larger portfolio.

Given these inputs, the model determines which subset of components should be provided each period and subsequently which configurations should use substitute components (if available) or dropped entirely (if no substitutes for a given base component, nor the base component itself, are provided). The provision of components in each period is given by xⁱ_{j,t}, provision of configurations in each period is given by z_{a,t}, and substitution of (i,j) by its k th alternative is given by yⁱ_{j,k,t}, x, z, and y are all binary variables, equal to 1 if the model determines if the given configuration, component, or substitute should be used, and 0 otherwise.

The problem of optimizing the product portfolio can be formulated as a Mixed Integer Program (MIP). One example of a MIP solver software is IBM ILOG CPlex® software.

Input parameters include which configurations and components are available, profit and cost data, demand(volume) data, valid substitutes for each component, configuration-component mapping data, maximum portfolio size, initial component provision status and a discount rate.

Variables include those to keep track of configuration and component provision in each period, which substitutes are used in which configurations, and how many times components have changed provision status.

In an examplary embodiment, a function desired to be maximized represents profit from sales of the product configurations, and can be thought of as having two main parts: the first part represents profit coming from sales of provided configurations if their base components were used, and the second part is basically a correction factor, adjusting for the difference in profit if a substitute component is used. This profit is then aggregated over all provided configuration, over all time periods (with an appropriate discount factor).

In an examplary embodiment, the constraints to the mixed integer program insure five types, C1, . . . , C5, of restrictions on the solution. Configuration Provision C1 provides that a given configuration cannot be provided unless its base component or a valid substitute is provided. Substitution Rules C2 provides that a substitution priority must be observed; i.e. a component cannot be used as a substitute in a configuration if a more preferred component is provided in a given period. Portfolio Complexity C3 provides that he total number of components provided in each period cannot exceed a predetermined limit. Status Changes C4 provides that given component cannot change provision status more than once during the planning horizon. Supply Constraint C5 provides that component use in configurations cannot exceed supply.

Parameters are aεA: possible server configuration, iεI: family of components, such as hard drives, processors, memory, (i,j)εJᵢ: component within given family, fₐ: profit margin of a, cₐ: total costs of a, v_{a,t}: total volume of a in period t, oⁱ(a): the index of the component of family i that is used for configuration a, sⁱ(j,k): index of k th alternative of (i,j), fⁱ_{j,k}: adjusted profit margin when component j is substituted by its k th alternative, cⁱⱼ: cost of component (i,j), bⁱₜ(a): number of component of family i used for configuration a in period t (Assume that only one type is used for each configuration), nⁱⱼ: total number of alternatives of component (i,j), αⁱₜ: maximum number of components in family i at time t,β: discount rate and gⁱⱼ: initial component provision status, Uⁱ_{j,t}: supply volume of component j in family i at time t.

Decision variables comprise key output variables and auxiliary variables. Key output variables are z_{a,t}: indicates whether configuration a can be provided in period t, xⁱ_{j,t}: indicates whether component (i,j) is provided in period t yⁱ_{j,k,t}: indicates whether component (i,j) is substituted by its k th alternative in period t and vⁱ_{a,j,t}: indicates the quantity of component (i,j) provided to configuration a in period t.

One auxiliary variable is wⁱ_{a,k,t}: 1 if configuration a is provided but its component (i, oⁱ(a)) is substituted by its k th alternative in period t. 0 otherwise.

Another auxiliary variable is rⁱ_{j,t}: 1 if component (i,j) changes status in time t. 0 otherwise.

In one aspect, a Mixed integer programming formulation is

$$max {\sum }_{t} {\sum }_{a} {β}^{t} [ \begin{matrix}{z}_{a , t} {f}_{a} {c}_{a} {V}_{a , t} + \\ {\sum }_{i ∈ \{ HD , SM \}} {\sum }_{k = 0}^{{n}_{{o}^{i} ( a )}^{i}} {w}_{a , k , t}^{i} ( \begin{matrix}{f}_{{o}^{i} ( a ) , k}^{i} {c}_{{s}^{i} ( {o}^{i} ( a ) , k )}^{i} - \\ {f}_{a} {c}_{{o}^{i} ( a )}^{i}\end{matrix} ) {V}_{a} {b}_{t}^{i} ( a )\end{matrix} ]$$

$$s . t . x , y , z , r ∈ \{ 0 , 1 \}$$

$$0 \leq w \leq 1$$

$$v \geq 0$$

(C1), Substitution is Possible Only when the Alternative Component is Provided

yⁱ_{j,k,t}≦xⁱs_{ⁱ}_{(j,k),t} for each i,j,k,t

(C1), Configuration a can be Provided Only when Both Components can be Fulfilled

$${Iz}_{a , t} \leq {\sum }_{i} ( {x}_{{o}^{i} ( a ) , t}^{i} + {\sum }_{k = 0}^{{n}_{{o}^{i} ( a )}^{i}} {y}_{{o}^{i} ( a ) , k , t}^{i} ) for each a , t$$

$${z}_{a , t} \geq {\sum }_{i} ( {x}_{{o}^{i} ( a ) , t}^{i} + {\sum }_{k = 0}^{{n}_{{o}^{i} ( a )}^{i}} {y}_{{o}^{i} ( a ) , k , t}^{i} ) - ( I - 1 ) for each a , t$$

### (C1) Properly Indicate w

wⁱ_{a,k,t} for each a,k,t

wⁱ_{a,k,t}≦yⁱₒ_{ⁱ}_{(a),k,t} for each a,k,t

wⁱ_{a,k,t}≧z_{a,t}+yⁱₒ_{ⁱ}_{(a),k,t}−1 for each a,k,t

### (C2) Substitution Sequence Must be Observed

$$1 - {x}_{j , t}^{i} \geq {y}_{j , 0 , t}^{i} for each i , j , t ( first alternative )$$

$${y}_{j , 0 , t}^{i} \geq ( 1 - {x}_{j , t}^{i} ) + {x}_{{s}^{i} ( j , 0 ) , t}^{i} - 1 for each i , j , t \\ ( 1 - {x}_{j , t}^{i} ) + ( 1 - {x}_{{s}^{i} ( j , 0 ) , t}^{i} ) \geq 2 {y}_{j , 1 , t}^{i} for each i , j , t ( second )$$

$${y}_{j , 1 , t}^{i} \geq ( 1 - {x}_{j , t}^{i} ) + ( 1 - {x}_{{s}^{i} ( j , 0 ) , t}^{i} ) + {x}_{{s}^{i} ( j , 1 ) , t}^{i} - 2 for each i , j , t \\ ( 1 - {x}_{j , t}^{i} ) + ( 1 - {x}_{{s}^{i} ( j , 0 ) , t}^{i} ) + ( 1 - {x}_{{s}^{i} ( j , 1 ) , t}^{i} ) \geq 3 {y}_{j , 2 , t}^{i}$$

$$for each i , j , t ( third )$$

$${y}_{j , 2 , t}^{i} \geq ( 1 - {x}_{j , t}^{i} ) + ( 1 - {x}_{{s}^{i} ( j , 0 ) , t}^{i} ) + ( 1 - {x}_{{s}^{i} ( j , 1 ) , t}^{i} ) + {x}_{{s}^{i} ( j , 2 ) , t}^{i} - 3$$

$$for each i , j , t \\ ( 1 - {x}_{j , t}^{i} ) + ( 1 - {x}_{{s}^{i} ( j , 0 ) , t}^{i} ) + ( 1 - {x}_{{s}^{i} ( j , 1 ) , t}^{i} ) + ( 1 - {x}_{{s}^{i} ( j , 2 ) , t}^{i} ) \geq 4 {y}_{j , 3 , t}^{i}$$

$$for each i , j , t ( fourth )$$

$${y}_{j , 3 , t}^{i} \geq ( 1 - {x}_{j , t}^{i} ) + ( 1 - {x}_{{s}^{i} ( j , 0 ) , t}^{i} ) + ( 1 - {x}_{{s}^{i} ( j , 1 ) , t}^{i} ) + ( 1 - {x}_{{s}^{i} ( j , 2 ) , t}^{i} ) {x}_{{s}^{i} ( j , 3 ) , t}^{i} - 4$$

$$for each i , j , t$$

$$⋮$$

### (C3) Total Number of Components we can Provide for Each Family is Limited

$${\sum }_{j} {x}_{j , t}^{i} \leq {α}_{t}^{i} ( {\sum }_{j} 1 ) for each i , t$$

### (C4) Component can Change Provision Status at Most Once

$${r}_{j , t}^{i} \geq {x}_{j , t}^{i} - {x}_{j , t - 1}^{i} for each i , j , t > 0$$

$${r}_{j , t}^{i} \geq {x}_{j , t - 1}^{i} - {x}_{j , t}^{i} for each i , j , t > 0$$

$${r}_{j , 0}^{i} \geq {x}_{j , 0}^{i} - {g}_{j}^{i} for each i , j$$

$${r}_{j , 0}^{i} \geq {x}_{j}^{i} - {x}_{j , 0}^{i} for each i , j$$

$${\sum }_{t} {r}_{j , t}^{i} \leq 1 for each i , j$$

(C5) Component use in configurations cannot exceed supply

$${\sum }_{a} {v}_{a , j , t}^{i} \leq {U}_{j , t}^{i} for each i , j , t$$

$${\sum }_{k = 0}^{{n}_{{o}^{i} ( a )}^{i}} {v}_{a , s ( {o}^{i} ( a ) , k ) , t}^{i} = {z}_{a , t} {V}_{a , t} {b}^{i} ( a ) for each a , i , t$$

$${x}_{j , t}^{i} \geq \frac{{\sum }_{a} {v}_{a , j , t}^{i}}{{U}_{j , t}^{i}} for each i , j , t$$

$${x}_{j , t}^{i} \leq {\sum }_{a} {v}_{a , j , t}^{i} for each i , j , t$$

FIG. 3 symbolically shows an exemplary embodiment of a hardware configuration performing product portfolio optimization under customer choice. System 300 includes at least one processor or central processing unit (CPU) 311. The CPUs 311 are interconnected via a system bus 312 to a random access memory (RAM) 314, a read-only memory (ROM) 316, an input/output (I/O) adapter 318 (for connecting peripheral devices such as disk units 321 and tape drives 340 to bus 312), a user interface adapter 322 (for connecting a keyboard 324, a mouse 326, a speaker 328, a microphone 332 and/or other user interface device to bus 312), a communication adapter 334 for connecting system 300 to a data processing network, the Internet, an Intranet, a local area network (LAN), etc., and a display adapter 336 for connecting bus 312 to a display device 338 and/or a printer 339 (e.g., a digital printer of the like).

While the foregoing is directed to embodiments of the presently disclosed technology, other and further embodiments of the disclosed technology may be devised without departing from the basic scope thereof, and the scope thereof is determined by the claims that follow.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident, software, micro-code, etc.) or an embodiment combining software and hardware aspects that may all generally be referred to herein as a “circuit,” “module” or “system.”

Furthermore, aspects of the present disclosure may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of disclosed herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in FIGS. 1 to 3 illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the embodiments of the present disclosure have been described in detail, it should be understood that various changes and substitutions can be made therein without departing from spirit and scope of the disclosure as defined by the appended claims. Variations described for the present disclosure can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present disclosure.

Reference in the specification to “one embodiment” or to “an embodiment” means that a particular feature, structure, or characteristic described in connection with the embodiments is included in at least one embodiment. The appearances of the phrase “one embodiment” in various places in the specification are not necessarily all referring to the same embodiment.

1. A method for managing configurable products via solving an optimization problem having an objective function and a set of constraints, the method comprising:
collecting data from a software application and a user;
formulating the set of constraints based on the collected data, the set of constraints having a configuration provision constraint and a substitution rule constraint;
defining the optimization problem by the set of constraints and an optimization objective;
solving the optimization problem using the collected data, the set of constraints, the optimization objective and the objective function via mixed integer programming, including balancing a cost of a complex portfolio of products against a diminishing return for a large portfolio of products; and
outputting a solution of the optimization problem.

2. The method of claim 1, wherein the data collected from the application is non-user input comprising configuration data, configuration profit margins data, configuration demand forecast data, component manufacturing costs data and component inclusion costs data.

3. The method of claim 2, wherein the data collected from the user is user-input comprising component substitution preferences data and model parameters data.

4. The method of claim 3, wherein the set of constraints further comprises a portfolio complexity constraint and a status changes constraint.

5. The method of claim 4, wherein the set of constraints further comprises a supply constraint and a component supply forecast data.

6. The method of claim 5, wherein the optimization objective is to maximize a difference between a sum of revenue from a configuration sale with a base component and change in revenue due to a substitution of component and a component inclusion cost.

7. The method of claim 6, wherein the solving of the optimization problem is done via solving
$$max {\sum }_{t} {\sum }_{a} {β}^{t} [ \begin{matrix}{z}_{a , t} {f}_{a} {c}_{a} {V}_{a , t} + \\ {\sum }_{i ∈ \{ HD , SM \}} {\sum }_{k = 0}^{{n}_{{o}^{i} ( a )}^{i}} {w}_{a , k , t}^{i} ( \begin{matrix}{f}_{{o}^{i} ( a ) , k}^{i} {c}_{{s}^{i} ( {o}^{i} ( a ) , k )}^{i} - \\ {f}_{a} {c}_{{o}^{i} ( a )}^{i}\end{matrix} ) {V}_{a} {b}_{t}^{i} ( a )\end{matrix} ]$$
and wherein:
t represents time:
a represents a configuration;
β represents a user inpus model parameter data;
Z_{α,r} represents configuration portfolio changes data;
f_{α} represents configuration profit margins data;
c_{α} represents component manufacturing costs data for configuration a;
V_{α,t} represents a demand for configuration a in period t;
HD represents hard drive;
SM represents system memory;
nⁱ represents a component substitution preferences data;
oⁱ(a) represents a base component of configuration a;
wⁱ_{a,k,t} is an auxiliary variable that is either 1 or 0;
fⁱ_{oi(a), k} represents an adjusted profit margin;
cⁱ_{si(oi(a),k)} represents a cost of an alternative component;
cⁱₒᵢ₍ₐ₎ represents a cost of a base component of configuration a;
Vₐ represents a demand for configuration a;
bⁱₜ(a) represents a number of component of family I used for configuration a in period t.

8. A computer program product for managing configurable products via solving an optimization problem having an objective function and a set of constraints, the computer program product comprising:
at least one tangible device readable by a processing circuit and having computer readable instructions tangibly embodied therein for execution by the processing circuit, said computer readable instructions, when executing, performing the following:
collecting data from a software application and a user;
formulating the set of constraints based on the collected data, the set of constraints having a configuration provision constraint and a substitution rule constraint;
defining the optimization problem by the set of constraints and an optimization objective;
solving the optimization problem using the collected data, the set of constraints, the optimization objective and the objective function via mixed integer programming, including balancing a cost of a complex portfolio of products against a diminishing return for a large portfolio of products; and
outputting a solution of the optimization problem.

9. The computer program product of claim 8, wherein the data collected from the application is non-user input comprising configuration data, configuration profit margins data, configuration demand forecast data, component manufacturing costs data and component inclusion costs data.

10. The computer program product of claim 9, wherein the data collected from the user is user-input comprising component substitution preferences data and model parameters data.

11. The computer program product of claim 10, wherein the set of constraints further comprises a portfolio complexity constraint, a status changes constraint, a supply constraint and a component supply forecast data.

12. (canceled)

13. The computer program product of claim 11, wherein the optimization objective is to maximize a difference between a sum of revenue from a configuration sale with a base component and change in revenue due to a substitution of component and a component inclusion cost.

14. The computer program product of claim 13, wherein the solving of the optimization problem is done via solving
$$max {\sum }_{t} {\sum }_{a} {β}^{t} [ \begin{matrix}{z}_{a , t} {f}_{a} {c}_{a} {V}_{a , t} + \\ {\sum }_{i ∈ \{ HD , SM \}} {\sum }_{k = 0}^{{n}_{{o}^{i} ( a )}^{i}} {w}_{a , k , t}^{i} ( \begin{matrix}{f}_{{o}^{i} ( a ) , k}^{i} {c}_{{s}^{i} ( {o}^{i} ( a ) , k )}^{i} - \\ {f}_{a} {c}_{{o}^{i} ( a )}^{i}\end{matrix} ) {V}_{a} {b}_{t}^{i} ( a )\end{matrix} ]$$
and wherein:
t represents time:
a represents a configuration;
β represents a user inpus model parameter data;
Z_{α,t} represents configuration portfolio changes data;
f_{α} represents configuration profit margins data;
c_{α} represents component manufacturing costs data for configuration a;
V_{α,t} represents a demand for configuration a in period t;
HD represents hard drive;
SM represents system memory;
nⁱ represents a component substitution preferences data;
oⁱ(a) represents a base component of configuration a;
wⁱ_{a,k,t} is an auxiliary variable that is either 1 or 0;
fⁱ_{oi(a),k} represents an adjusted profit margin;
cⁱ_{si(oi)(a),k)} represents a cost of an alternative component;
cⁱₒᵢ₍ₐ₎ represents a cost of a base component of configuration a;
Vₐ represents a demand for configuration a;
bⁱₜ₍ₐ₎ represents a number of component of family I used for configuration a in period t.

15. A computer system for managing configurable products via solving an optimization problem having an objective function and a set of constraints, the system comprising:
a memory;
a processor in communications with the computer memory, wherein the computer system is configured for:
collecting data from a software application and a user;
formulating the set of constraints based on the collected data, the set of constraints having a configuration provision constraint and a substitution rule constraint;
defining the optimization problem by the set of constraints and an optimization objective;
solving the optimization problem using the collected data, the set of constraints, the optimization objective and the objective function via mixed integer programming, including balancing a cost of a complex portfolio of products against a diminishing return for a large portfolio of products; and
outputting a solution of the optimization problem.

16. The computer system of claim 15, wherein the data collected from the application is non-user input comprising configuration data, configuration profit margins data, configuration demand forecast data, component manufacturing costs data and component inclusion costs data.

17. The computer system of claim 16, wherein the data collected from the user is user-input comprising component substitution preferences data and model parameters data.

18. The computer system of claim 17, wherein the set of constraints further comprises a portfolio complexity constraint and a status changes constraint.

19. The computer system of claim 18, wherein the set of constraints further comprises a supply constraint and a component supply forecast data.

20. The computer system of claim 19, wherein the optimization objective is to maximize a difference between a sum of revenue from a configuration sale with a base component and change in revenue due to a substitution of component and a component inclusion cost.

21. The computer system of claim 20, wherein the solving of the optimization problem is done via solving
$$max {\sum }_{t} {\sum }_{a} {β}^{t} [ \begin{matrix}{z}_{a , t} {f}_{a} {c}_{a} {V}_{a , t} + \\ {\sum }_{i ∈ \{ HD , SM \}} {\sum }_{k = 0}^{{n}_{{o}^{i} ( a )}^{i}} {w}_{a , k , t}^{i} ( \begin{matrix}{f}_{{o}^{i} ( a ) , k}^{i} {c}_{{s}^{i} ( {o}^{i} ( a ) , k )}^{i} - \\ {f}_{a} {c}_{{o}^{i} ( a )}^{i}\end{matrix} ) {V}_{a} {b}_{t}^{i} ( a )\end{matrix} ]$$
and wherein:
t represents time:
a represents a configuration;
β represents a user inpus model parameter data;
Z_{α,r} represents configuration portfolio changes data;
f_{α} represents configuration profit margins data;
c_{α} represents component manufacturing costs data for configuration a;
V_{α,t} represents a demand for configuration a in period t;
HD represents hard drive;
SM represents system memory;
nⁱ represents a component substitution preferences data;
oⁱ(a) represents a base component of configuration a;
wⁱ_{a,k,t} is an auxiliary variable that is either 1 or 0;
fⁱ_{oi(a),k} represents an adjusted profit margin;
cⁱ_{si(oi(a),k)} represents a cost of an alternative component;
cⁱₒᵢ₍ₐ₎ represents a cost of a base component of configuration a;
Vₐ represents a demand for configuration a;
bⁱₜ₍ₐ₎ represents a number of component of family I used for configuration a in period t.

22. The computer system according to claim 15, wherein:
said data includes a product configuration and a component provision in a pre-determined time period and potential substitutes that can be used in which configurations;
the configuration provision constraint sets forth a base component of a product or valid substitutes thereof, and the substitution rule constraint defines a priority order in which components of a product configuration may be substituted over other components;
the optimization objective is profit-based, and said optimization problem includes a function representing a profit from sales of said provided configurations using said base component, and a correction factor adjusting for a difference in profit by using a substituted component;
the solving the optimization problem includes solving the optimization problem to determine a subset of components to be provided in a pre-determined time period and whether a product configuration should use one or more substitute components; and
the solution of the optimization problem comprises, in each time period, which component parts should be added or dropped from a product portfolio to maximize profit from sales of the configured products.

23. The computer system of claim 22, wherein the solution includes at least one of a component removal data, a component addition data, a component substitution decisions data, a configuration portfolio changes data, an optimal profits outlook data or a modified forecast of configuration demand data.

24. The computer system of claim 22, wherein said solving further comprising:
aggregating profit over all provided product configurations, over all a defined time periods;
aggregating with an appropriate discount factor representing a discounted price for a product configuration using a substitute component, which is between the price of the original product and the substitute; and
determining whether and which product configuration should be dropped in said each time period.

25. The computer system of claim 24, wherein the outputting further comprises determining in each time period, which component part should be added or dropped from the product portfolio in order to maximize profit from sales of the configured products, subject to a limit on the size of the portfolio in each period.

26. The method according to claim 1, further comprising using a computer system, implementing an optimization problem solving program, to perform the solving the optimization problem and the outputting a solution of the optimization problem.
